(19) United States
(12) Patent Application Publication
(10) Pub. No.: US 2006/0221230 A1
(43) Pub. Date: Oct. 5, 2006

(54) Mobile camera telephone

(75) Inventors: Amit Dutta, Tokyo (JP); Kazunobu Shin, Frisco, TX (US)

Correspondence Address: HARRINGTON & SMITH, LLP, 4 RESEARCH DRIVE, SHELTON, CT, 06484-6212, US

(73) Assignee: NOKIA CORPORATION, Espoo (FI)

(21) Appl. No.: 10/553,365

(22) PCT Filed: Apr. 17, 2003
(86) PCT No.: PCT/IB03/02018

§ 371 Date: Oct. 14, 2005

(51) Int. Cl. H04N 5/225

(52) U.S. Cl. 348/376

(57) ABSTRACT

A mobile camera telephone including a camera module for capturing an image and providing digital data in an RGB format; and an application processor including a CPU for controlling the operation of the telephone and hardware arranged to perform camera image processing on the digital data in RGB format received from the camera module. A method of recording an image using a mobile camera telephone comprising the steps of capturing an image in a first camera component of the mobile camera telephone sending digital data in an RGB format from the first component to a second application processing component of the mobile camera telephone; and, in the application processing component, both image processing the digital data in RGB format to produce an image for viewing and controlling the storage of that image in the telephone.

### FIELD OF THE INVENTION

Embodiments of the invention relate to mobile camera telephones. That is a mobile device which is operable as a digital camera and operable as a mobile radio communications device.

### BACKGROUND TO THE INVENTION

FIG. 1 is a schematic illustration of a conventional mobile camera telephone 10. The telephone 10 includes, as distinct components, optics and image sensor 12, a camera co-processor 14 and an application processor 16. The optics and. image sensor 12 captures an image and produces a digital output 11 representing the image. The camera co-processor 14 is a chip that processes the digital data 11 using a specially optimized image processing hardware accelerator to produce image data 13. The application processor 16 is the central processing unit (CPU) of the telephone. It controls the operation of the telephone and, in particular, the input, output and the-user applications available on the telephone. The application processor 16, for example, controls memory devices such as SDRAM 2 and multimedia memory card 4, to which image data 13 can be stored. It may control the digital baseband circuitry (DSP) 6 which may be used to processes telecommunications made via the telephone 10. In other implementations, the telephone 10 has an additional processor that is dedicated to controlling the digital baseband circuitry 6.

The mobile telephone functions and the mobile camera functions are performed by separate components. The optics and image sensor 12 and camera co-processor chip 14 provide the mobile camera functions and may be supplied as a single module or chip 18 for integration into the body of the telephone 10. The application processor 16 is another module or chip that provides the mobile phone functions, and may provide image storage and playback functions.

It would be desirable to improve the architecture of a mobile camera phone.

### BRIEF DESCRIPTION OF THE INVENTION

According to one aspect of the present invention there is provided a mobile camera telephone comprising: a camera module for capturing an image and providing digital data in a RAW format; and an application processor including a CPU for controlling the operation of the telephone and hardware arranged to perform camera image processing on the digital data in RAW format received from the camera module.

According to another aspect of the present invention there is provided a method of recording an image using a mobile camera telephone comprising the steps of: capturing an image in a first camera component of the mobile camera telephone; sending digital data in a RAW format from the first camera component to a second application processing component of the mobile camera telephone; and, in the second application processing component, both image processing the digital data in RAW format to produce an image for viewing and controlling the storage of that image in the telephone.

“RAW” format means a data format obtained by digitizing analog data outputted from an image sensor such as a CMOS sensor or a CCD sensor. An image for viewing or storage is typically in RGB format, YUV format, or a compressed format such as JPEG or TIFF.

Embodiments of the invention therefore have a reduced number of components for camera modules. The functions of the imaging co-processor of the camera module in the prior art have been integrated as hardware or software into the application processor. The size and cost of the camera module is consequently reduced.

According to some embodiments of the invention the camera module comprises reducing means for reducing the size of the provided digital data. This obviates the need for an expensive wide bandwidth interface between the camera module and the application processor.

### BRIEF DESCRIPTION OF THE FIGURES

For a better understanding of the invention reference will now be made by way of example only to the accompanying Figures in which:

FIG. 1 is a schematic illustration of a conventional mobile camera telephone 10;

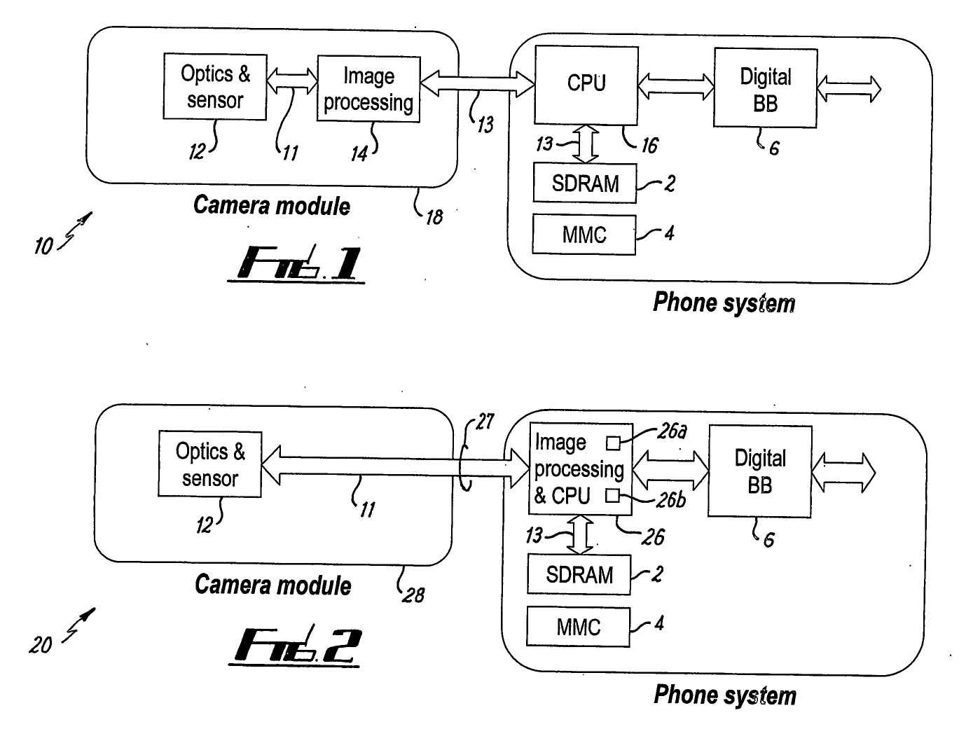

FIGS. 2 and 3 are schematic illustrations of a mobile camera telephone 20 according to a first embodiment of the invention;

FIG. 4 illustrates one alternative embodiment of the invention; and

FIG. 5 illustrates another alternative embodiment of the invention.

### DETAILED DESCRIPTION OF THE EMBODIMENTS OF THE INVENTION

The Figures illustrate a mobile camera telephone 20 comprising: a camera module 28 for capturing an image and providing digital data 11 in an RAW format; and an application processor 26 including a CPU 26a for controlling the operation of the telephone and hardware 26b arranged to perform camera image processing on the digital data in RAW format received from the camera module to produce image data 13 that is suitable for viewing an on digital display. The image data 13 is stored under the control of the CPU 26a.

RAW format means a data format obtained by digitizing analog data outputted from an image sensor such as a CMOS sensor or a CCD sensor. The data image for viewing or storage may be in RGB format, YUV format, or compressed format such as JPEG or TIFF format.

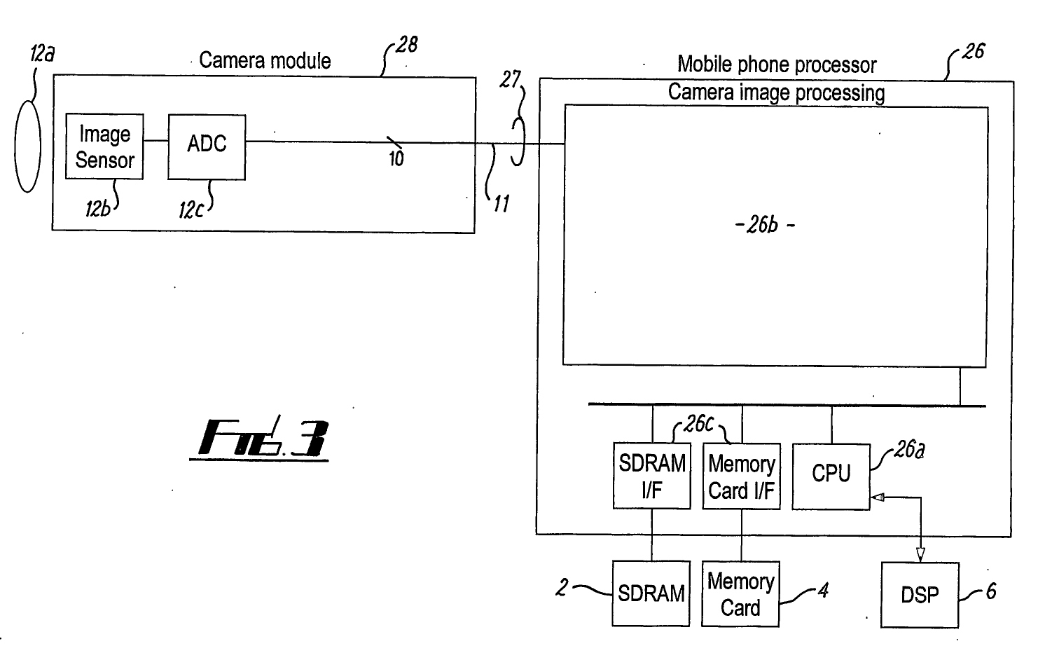

FIGS. 2 and 3 are schematic illustrations of a mobile camera telephone 20 according to a first embodiment of the invention. The telephone 20 includes, as distinct components, an optics and image sensor 12 and an application processor 26. The application processor 26 is a single chip. It has a CPU block 26a that operates as the CPU of the telephone 20, a camera image processing block 26b that operates as a camera image processor and interfaces 26c to storage devices SDRAM 2 and memory card 4. The application processor 26 may be a system on a chip (SOC).

The optics and image sensor 12 are part of a camera module 28. The optics and image sensor 12 includes a lens 12a, an image sensor block 12b with an analogue to digital converter (ADC) block 12c. It captures an image and produces a digital output 11 representing the image. The digital output 11 is Bayer data, which is RGB color data corresponding to the color filter used in the image sensor 12. The ‘raw’ digital output 11 is passed across an interface 27 between the camera module 28 and the application processor 26.

The application processor 26 processes the digital data 11 using special image processing capabilities, provided by the camera image processing block 26b, to produce image data 13 . The application processor 26 includes the central processing unit (CPU) block 26a of the telephone, which controls the operations of the telephone and, in particular, the input, output and the user applications available on the telephone. The application processor 26, for example, controls memory devices such as SDRAM 2 and multimedia memory card 4, to which image data 13 can be stored. It also gives some control to the digital baseband circuitry 6 which may be used to processes telecommunications made via the telephone 10.

The mobile phone functions and the mobile camera functions are substantially performed by the same component, the application processor 26 within the camera image processing block 26b. (In other embodiment some of the mobile phone functions may be performed by another processor.) The optics and image sensor 12 is provided as a simple small and cheap module 28 for integration into the body of the telephone 20. In this embodiment, it provides the mobile camera image capturing functions and A/D conversion, but does not provide the further image processing functions that construct final image data for viewing in a display or storage in memory. The application processor 26 provides the mobile camera data processing functions and the mobile telephone control functions.

The camera image processing functionality of the application processor 26 may be provided within the application processor 26 by a dedicated hard-wired pipeline processor separate to the CPU processor or by a dedicated programmable hardware accelerator that may be an extension to the CPU. The advantage of a programmable hardware accelerator is that it can be adapted by programming to operate with different image sensor modules 28. One type of programmable hardware accelerator is a SIMD (single instruction multiple data) processing accelerator that is optimized for camera image processing.

The image processing may include: defect correction, gain control, black level offset matching, white balancing, gamma control, CFA interpolation and color space conversion, edge enhancement and data compression. The operations need not be carried out in the above order.

The camera image processing block 26b of the application processor 26 may involve the CPU block 26a and/or the digital baseband circuitry (DSP) 6 in the image processing operations.

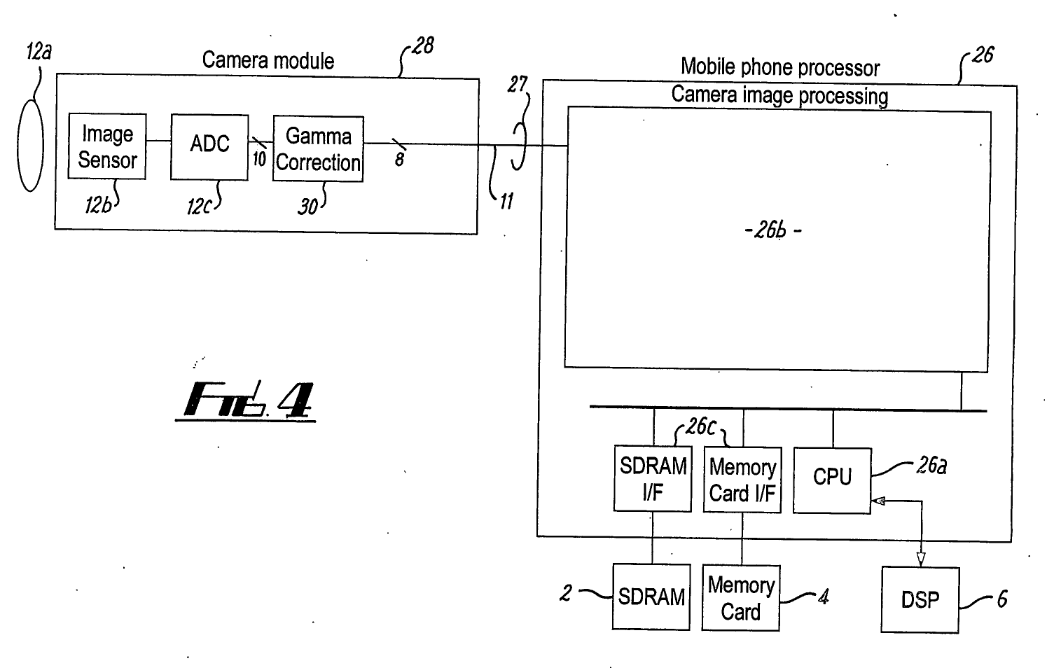

FIG. 4 illustrates an alternative embodiment of the invention. The digital data 11 is size reduced before being sent across the interface 27, to make bandwidth of the interface 27 smaller. In the example of FIG. 4, the digital data 11 is bit depth reduced from 10 bits, at the output of the ADC 12c to 8 bits when it crosses the interface 27. The bit reduction, in this example, is performed as part of gamma correction by a gamma correction block 30. The image processing function of gamma correction is performed in the camera module 28 by gamma correction block 30 instead of the camera image processing block 26b of the application processor 26.

The module 28 performs some limited image processing, but the majority is carried out by the camera image processing block 26b of the application processor 26. The module 28 remains simple small and cheap module and is easily integrated into the body of the telephone 20. The module 28 provides the mobile camera image capturing functions, A/D conversion, data bandwidth reduction and, may provide some limited image processing functions (gamma correction). The application processor 26 provides the majority of camera data processing functions to construct final image data and the mobile telephone control functions. And, the bandwidth of interface 27 in this embodiment can be smaller than that in the previous embodiment shown in FIG. 3.

The camera image processing functionality of the application processor may be provided within the application processor 26 by a dedicated hard-wired pipeline processor separate to the CPU processor or by a dedicated programmable hardware accelerator that may be an extension to the CPU.

The camera image processing block 26b of the application processor 26 may involve the CPU block 26a and/or the DSP 6 in the image processing operations.

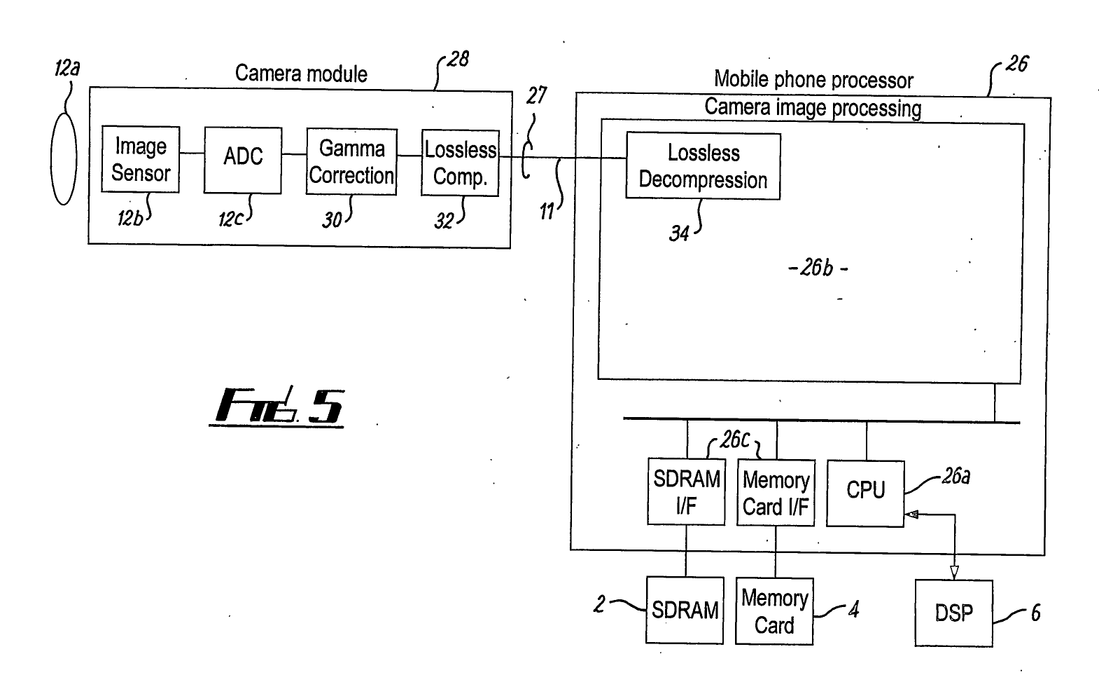

FIG. 5 illustrates a modification to the alternative embodiment of the invention described with reference to FIG. 4. The digital data 11 is losslessly compressed before being sent across the interface 11 by the lossless compression block 32. In the example of FIG. 5, the digital data is first bit depth reduced from 10 bits, at the output of the ADC 12c to 8 bits by a gamma correction block 30. The gamma corrected digital data is then losslessly compressed by compression block 32 before being sent across the interface 27 as digital data 11. In this embodiment, the bandwidth of interface 27 can be smaller than that in the embodiment shown in FIG. 4.

The camera image processing performed by the camera image processing block 26b of the application processor 26 additionally includes lossless decompression by decompression block 34 at the interface 27 before image processing takes place.

The module 28 performs data compression and may perform some limited image processing, but the majority is carried out by the camera image processing block 26b of the application processor 26. The module 28 remains simple small and cheap module and is easily integrated into the body of the telephone 20. The module 28 provides the mobile camera image capturing functions, data bandwidth reduction by lossless compression and, may provide some limited image processing functions (gamma correction). The application processor 26 provides lossless decompression and at least the majority mobile camera data processing functions and the mobile telephone control functions.

The camera image processing functionality of the application processor 26 may be provided within the application processor 26 by a dedicated hard-wired pipeline processor separate to the CPU processor or by a dedicated programmable hardware accelerator that may be an extension to the CPU.

The camera image processing block 26b of the application processor 26 may involve the CPU block 26a and/or the DSP 6 in the image processing operations.

The module may be integrated into the body of the telephone or may be user attachable/detachable to the body of the telephone.

Although embodiments of the present invention have been described in the preceding paragraphs with reference to various examples, it should be appreciated that modifications to the examples given can be made without departing from the spirit or scope of the invention.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A mobile camera telephone comprising:
a camera module for capturing an image and providing digital data in an RAW format; and
an application processor including a CPU for controlling the operation of the telephone and hardware arranged to perform camera image processing on the digital data in RAW format received from the camera module.

2. A mobile camera telephone as claimed in claim 1, wherein the camera module comprises optics, an image sensor and an analogue to digital converter only, and is without image processing facility.

3. A mobile camera telephone as claimed in claim 1, wherein the digital data is the digitized output of an image sensor.

4. A mobile camera telephone as claimed in claim 1 wherein the camera module comprises reducing means for reducing the size of the provided digital data.

5. A mobile camera telephone as claimed in claim 4, wherein the reducing means involves bit depth reduction.

6. A mobile camera telephone as claimed in claim 4, wherein the reducing means involves lossless compression and the application processor includes means for lossless decompression before image processing.

7. A mobile camera telephone as claimed in claim 1, wherein the camera module further comprises means for predetermined and limited image processing.

8. A mobile camera telephone as claimed in claim 1, wherein the camera module further comprises gamma correction means for gamma correcting the digital data before its provision to the application processor.

9. A mobile camera telephone as claimed in claim 1, wherein the application processor performs camera image processing excluding gamma correction.

10. A mobile camera telephone as claimed in claim 1, wherein the application processor is a system on a chip.

11. A mobile camera telephone as claimed in claim 1, wherein the application processor includes a hard-wired pipeline processor for camera image processing.

12. A mobile camera telephone as claimed in claim 1, wherein the application processor includes a programmable hardware accelerator.

13. A mobile camera telephone as claimed in claim 12, wherein the programmable hardware accelerator is a SIMD processing accelerator optimized for camera image processing.

14. A method of recording an image using a mobile camera telephone comprising
the steps of:
capturing an image in a first camera component of the mobile camera telephone sending digital data in an RAW format from the first camera component to a second application processing component of the mobile camera telephone; and,
in the second application processing component, both image processing the digital data in RAW format to produce an image for viewing and controlling the storage of that image in the telephone.
